(19) United States
(12) Patent Application Publication
(10) Pub. No.: US 2016/0210663 A1
(43) Pub. Date: Jul. 21, 2016

(54) Method and System for Determining Advertisement to Be Displayed Based on Price Bid for Peripheral Sensing Information

(71) Applicant: Korea Advanced Institute of Science and Technology, Daejeon (KR)

(72) Inventors: Jun Kyun Choi, Daejeon (KR); Jin Hong Yang, Daejeon (KR); Hyo Jin Park, Daejeon (KR); Kyu Yeong Jeon, Daejeon (KR)

(73) Assignee: Korea Advanced Institute of Science and Technology, Daejeon (KR)

(21) Appl. No.: 14/623,366

(22) Filed: Feb. 16, 2015

(30) Foreign Application Priority Data
Jan. 21, 2015 (KR) 10-2015-0009845

(51) Int. Cl. G06Q 30/02

(52) U.S. Cl. CPC G06Q 30/0251

(57) ABSTRACT

An advertisement display determining method configured as a computer may include: collecting situation information from at least one sensor of a digital signage device; registering advertisement content based on setting information input from an advertiser or campaign setting information input to a campaign template selected by the advertiser; extracting the advertisement content corresponding to the situation information in response to matching between the setting information input from the advertiser or the campaign setting information input from the advertiser and the situation information; and providing the extracted advertisement content to the digital signage device, and logging the advertisement content for differentially determining a charge based on the situation information.

### CROSS-REFERENCE TO RELATED APPLICATION

This application claims the priority benefit of Korean Patent Application No. 10-2015-0009845, filed on Jan. 21, 2015, in the Korean Intellectual Property Office, the disclosure of which is incorporated herein by reference.

### BACKGROUND

1. Field of the Invention

The following description relates to an advertisement service technology and more particularly, to a method and system for displaying an advertisement on a digital signage device.

2. Description of the Related Art

In general, a variety of digital screens are being distributed in a form of a digital signage or a digital wall indicating a billboard using a digital information display (DID). Users encounter media on a digital screen in a predetermined space or while the users are moving.

However, an advertisement display method using a digital signage or a digital wall may only repeatedly play back the same content and may not provide optimal content based on a user behavior around the digital signage or the digital wall. Also, the advertisement display method according to the related art has some issues in that advertisers have complaints about the enforcement effect and a response rate of the advertisers over the overall advertisement exposure is relatively low.

Accordingly, there is a need for a technology that may effectively display advertisement content in association with a peripheral situation of a digital signage device.

Korean Laid-Open Publication No. 10-2011-0083393 discloses a digital signage device that enables a user to intuitively and easily verify and edit content information, and a method of controlling the digital signage device.

### SUMMARY

An advertisement display determining system according to an embodiment provides a method of displaying advertisement content optimal for a situation by collecting situation information from a sensor of a digital signage device and by recognizing and determining a peripheral situation based on the collected situation information.

An advertisement display determining system according to an embodiment also provides a method of bidding for situation information of a digital signage device, displaying advertisement information based on the situation information, and differentially determining a charge based on the situation information.

According to an embodiment, there is provided an advertisement display determining method configured as a computer, the method including: collecting situation information from at least one sensor of a digital signage device; registering advertisement content based on setting information input from an advertiser or campaign setting information input to a campaign template selected by the advertiser; extracting the advertisement content corresponding to the situation information in response to matching between the setting information input from the advertiser or the campaign setting information input from the advertiser and the situation information; and providing the extracted advertisement content to the digital signage device, and logging the advertisement content for differentially determining a charge based on the situation information.

According to an aspect, the registering of the advertisement content may include: providing a setting information interface for receiving the setting information from the advertiser or a campaign template interface for receiving the campaign setting information from the advertiser; and outputting a setting result for displaying the advertisement content in response to the setting information input through the setting information interface or the campaign template interface.

According to another aspect, the registering of the advertisement content may include receiving, from the advertiser, a setting on the campaign setting information or an advertisement type for displaying the advertisement content through the campaign template.

According to still another aspect, the providing and the logging may include logging the situation information about a point in time at which the advertisement content is displayed through the digital signage device.

According to still another aspect, the providing and the logging may include logging information created in response to an interaction between the displayed advertisement content and an outside, and differentially determining the charge by assigning a weight to the created information.

According to still another aspect, the extracting may include receiving a response result to the displayed advertisement content in real time, and recommending the advertisement content corresponding to the received response result and the situation information.

According to still another aspect, the collecting may include collecting at least one situation information among the number of users recognizable from the digital signage device, a presence or an absence of a motion of a recognizable user, a travel speed of the recognizable user, recognizable user information, and temperature information, humidity information, illumination information, sound information, and CO2 information that are recognized from the digital signage device, and information of the digital signage information, and correcting the collected situation information.

According to another embodiment, there is provided an advertisement display determining system configured as a computer, the system including: a situation information collector configured to collect situation information from at least one sensor of a digital signage device; a register configured to register advertisement content based on setting information input from an advertiser or campaign setting information input to a campaign template selected by the advertiser; an extractor configured to extract the advertisement content corresponding to the situation information in response to matching between the setting information input from the advertiser or the campaign setting information input from the advertiser and the situation information; and a logger configured to provide the extracted advertisement content to the digital signage device, and to log the advertisement content for differentially determining a charge based on the situation information.

According to an aspect, the register may be configured to provide a setting information interface for receiving the setting information from the advertiser or a campaign template interface for receiving the campaign setting information from the advertiser, and to output a setting result for displaying the advertisement content in response to the setting information input through the setting information interface or the campaign template interface.

According to another aspect, the register may be configured to receive, from the advertiser, a setting on the campaign setting information or an advertisement type for displaying the advertisement content through the campaign template.

According to still another aspect, the logger may be configured to log the situation information about a point in time at which the advertisement content is displayed through the digital signage device.

According to still another aspect, the logger may be configured to log information created in response to an interaction between the displayed advertisement content and an outside, and to differentially determine the charge by assigning a weight to the created information.

According to still another aspect, the extractor may be configured to receive a response result to the displayed advertisement content in real time, and to recommend the advertisement content corresponding to the received response result and the situation information.

According to still another aspect, the situation information collector may be configured to collect at least one situation information among the number of users recognizable from the digital signage device, a presence or an absence of a motion of a recognizable user, a travel speed of the recognizable user, recognizable user information, and temperature information, humidity information, illumination information, sound information and CO2 information that are recognized from the digital signage device, and information of the digital signage information, and to correct the collected situation information.

According to still another embodiment, there is provided non-transitory computer-readable media including an instruction to control a computer system to determine an advertisement to be displayed, wherein the instruction controls the computer system by a method including: collecting situation information from at least one sensor of a digital signage device; registering advertisement content based on setting information input from an advertiser or campaign setting information input to a campaign template selected by the advertiser; extracting the advertisement content corresponding to the situation information in response to matching between the setting information input from the advertiser or the campaign setting information input from the advertiser and the situation information; and providing the extracted advertisement content to the digital signage device, and logging the advertisement content for differentially determining a charge based on the situation information.

Effect

According to embodiments, an advertisement display determining system may recommend advertisement content optimal for situation information in response to matching between setting information input from an advertiser and the situation information.

Also, according to embodiments, an advertisement display determining system may display advertisement content based on a display characteristic for each situation and may differentially determine a charge by logging information about the advertisement content and by assigning a weight in response to an interaction between the displayed advertisement content and an outside.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a relationship between an advertisement display determining system and a digital signage device according to an embodiment;

FIG. 2 is a diagram to describe an operation of an advertisement display determining system and a digital signage device according to an embodiment;

FIG. 3 is a block diagram illustrating a configuration of an advertisement display determining system according to an embodiment;

FIG. 4 illustrates a process of registering advertisement content by inputting setting information of an advertisement display determining system according to an embodiment;

FIG. 5 illustrates an example of displaying advertisement content on a digital signage device according to an embodiment;

FIG. 6 is a flowchart illustrating a method of registering advertisement content from an advertiser in an advertisement display determining system according to an embodiment;

FIG. 7 is a flowchart illustrating an advertisement display determining method of an advertisement display determining system according to an embodiment; and

FIG. 8 is a block diagram illustrating a configuration of a computer system according to an embodiment.

### DETAILED DESCRIPTION

Reference will now be made in detail to embodiments of the present disclosure, examples of which are illustrated in the accompanying drawings, wherein like reference numerals refer to like elements throughout. Embodiments are described below to explain the present disclosure by referring to the figures.

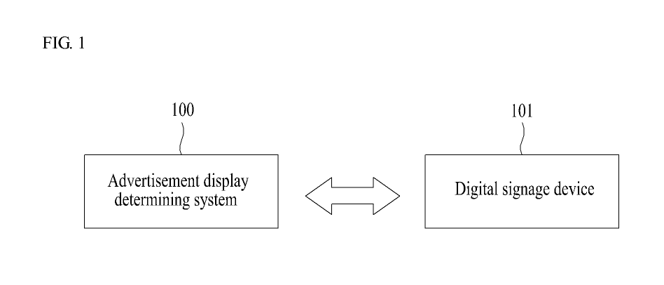

FIG. 1 illustrates a relationship between an advertisement display determining system and a digital signage device according to an embodiment. FIG. 1 illustrates an advertisement display determining system 100 and a digital signage device 101. In FIG. 1, an indicator with an arrowhead may indicate that data may be transmitted and received between the advertisement display determining system 100 and the digital signage device 101 over a wired/wireless network.

The digital signage device 101 may refer to, for example, a smartphone and a digital screen, and may include media on a digital screen while users are present in a predetermined space or moving. The digital signage device 101 may refer to any type of terminal devices capable of connecting to a website/mobile site associated with the advertisement display determining system 100 or installing and executing a service exclusive application. Here, the digital signage device 101 may perform the overall service operation such as a service screen configuration, a data input, a data transmission and reception, and a data storage under a control of the website/mobile site or the exclusive application.

The advertisement display determining system 100 performs the functionality as a service platform to provide a service of displaying an advertisement with respect to the digital signage device 101 corresponding to a client. In this instance, the advertisement display determining system 100 may collect situation information from a sensor, and may display advertisement content optimal for a situation on the digital signage device 101.

The advertisement display determining system 100 may be configured to be included in a platform of an advertisement display determining server (not shown) to provide an advertisement display service, and may also be configured as a system separate from the advertisement display determining server and to determine an advertisement to be displayed through an interaction with the advertisement display determining server. Also, at least a portion of constituent elements of the advertisement display determining system 100 may be configured in a form of an application to be installed in the digital signage device 101. Alternatively, the advertisement display determining system 100 may be configured to be included in a platform to provide a service in a client-server environment.

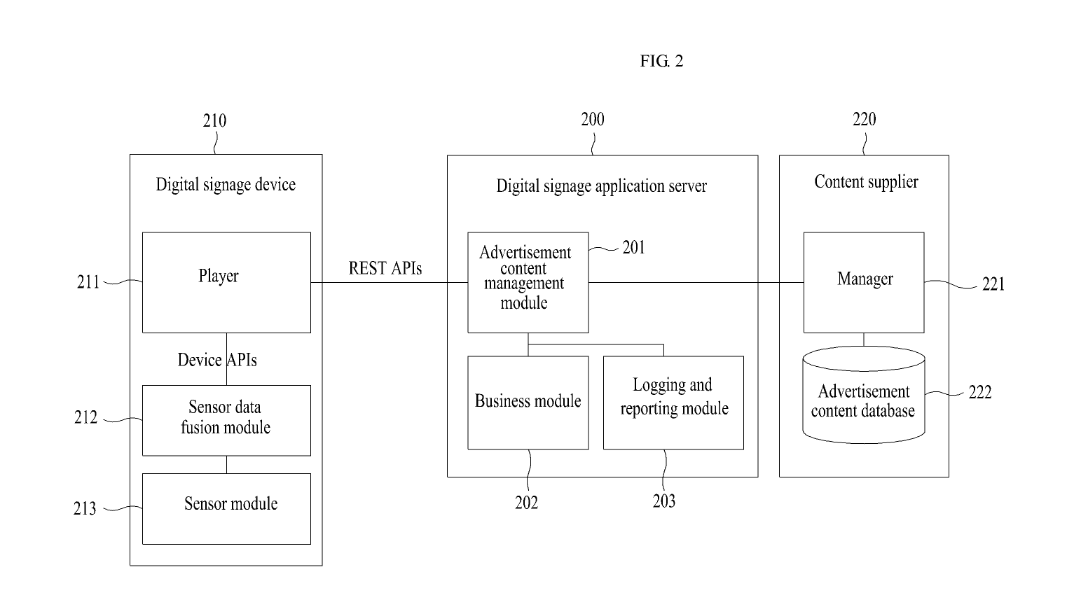

FIG. 2 is a diagram to describe an operation of an advertisement display determining system and a digital signage device according to an embodiment.

A digital signage application server 200 may transmit situation information acquired from a digital signage device 210 to a content supplier 220 to display advertisement content based on situation information. In this instance, a device application program interface (API) with a sensor module 213 is required to process and thereby transmit situation information sensed from the digital signage device 210 in a REST API form.

The digital signage device 210 may include a player 211 to play back advertisement content, a sensor data fusion module 212, and the sensor module 213 to collect peripheral situation information of the digital signage device 210.

The player 211 of the digital signage device 210 may operate through a player program driven in the digital signage device 210 or through a web browser. Here, the player 211 may provide a connection function through the device API when an external application such as a web browser is used for connection to the digital signage device 210.

The sensor module 213 is to acquire situation information from at least one sensor of the digital signage device 210, and may include various sensors. For example, the sensor module 213 may include a temperature sensor, a humidity sensor, an illumination sensor, a microphone sensor, a proximity sensor, a camera sensor, a depth sensor, and an infrared (IR) sensor. Here, a sensor may be added to or removed from the sensor module 213. A plurality of sets of situation information may be further created or reduced based on the sensor added to or removed from the sensor module 213.

The sensor data fusion module 212 may secure correction and elaboration through a data fusion in order to increase accuracy of sensor data acquired from the sensor module 213. In this instance, the sensor data fusion module 213 may be selectively included in the digital signage device 210, or may not be included therein.

The digital signage application server 200 may operate in the advertisement display determining system, and may include an advertisement content management module 201 to respond to advertisement content requested from the digital signage device 210, a business module 202 to provide optimal advertisement content, and a logging and reporting module 203 to log information about the displayed advertisement content.

The advertisement content management module 201 may provide a response to the advertisement content requested from the digital signage device 210. When the advertisement content management module 201 has a separate advertisement content delivery function, the advertisement content management module 201 may be separately connected to the digital signage device 210.

The business module 202 may perform a management in order to display the optimal advertisement content based on a characteristic of each digital signage device 210, based on the player 211 having secured a screen of the digital signage device 210 based on a predetermined criterion, for example, for each device, for each area, and a predetermined time zone.

The business module 202 may provide an effective advertisement service by calculating a weight of each of advertisement contents bid for by an advertiser, and by continuously applying user reactions accumulated from a point in time at which corresponding advertisement content is displayed.

The logging and reporting module 203 may log and record information about the displayed advertisement content to provide a transparency of the displayed advertisement content.

The content supplier 220 may include a manager 221 to provide advertisement content based on situation information acquired from the digital signage device 210 and to determine a charge. Here, the manager 221 may include an advertisement content database 222 to log information about the advertisement content. When a request for advertisement content is received from the digital signage device 210, the manager 221 may extract advertisement content corresponding to the situation information acquired from the digital signage device 210. In this instance, the manager 210 may effectively display advertisement content by receiving a response result to the displayed advertisement content and by recommending advertisement content corresponding to the received response result and the situation information of the digital signage device 210.

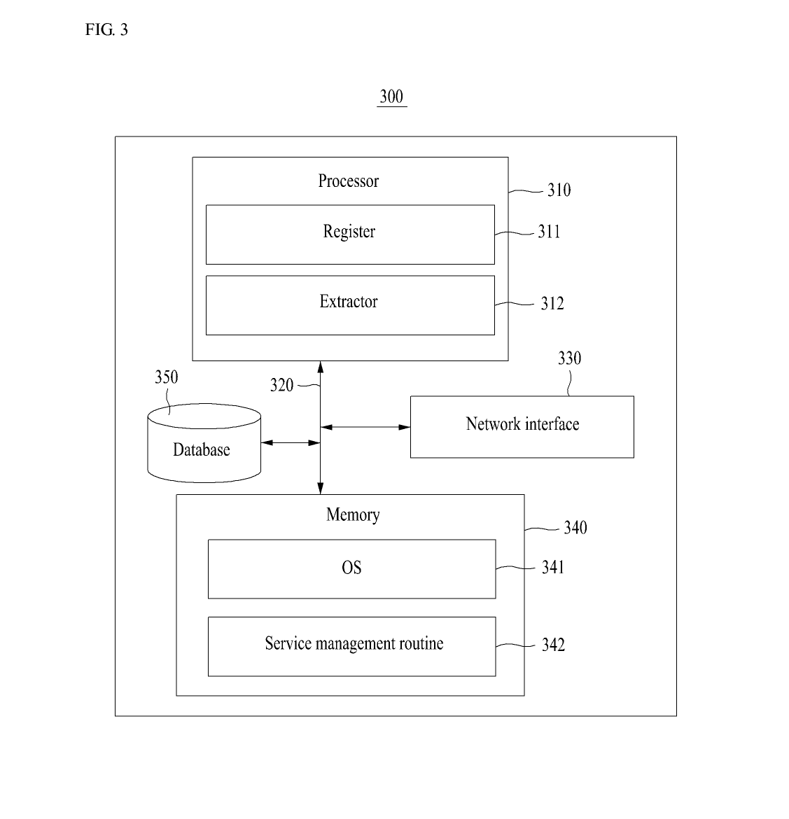

FIG. 3 is a block diagram illustrating a configuration of an advertisement display determining system 300 according to an embodiment.

Referring to FIG. 3, the advertisement display determining system 300 may include a processor 310, a bus 320, a network interface 330, a memory 340, and a database 350. The memory 340 may include an operating system (OS) 341 and a service management routine 342. The processor 310 may include a register 311 and an extractor 312. According to other embodiments, the advertisement display determining system 300 may include a more number of constituent elements than the number of constituent elements of FIG. 3. However, many conventional constituent elements do not require to be clearly illustrated. For example, the advertisement display determining system 300 may also include other constituent elements such as a display or a transceiver.

The memory 340 refers to computer-readable storage media and may include a permanent mass storage device such as random access memory (RAM), read only memory (ROM), and a disk drive. Also, a program code for the OS 341 and the service management routine 342 may be stored in the memory 340. The above software constituent elements may be loaded from non-transitory computer-readable media separate from the memory 340, using a drive mechanism (not shown). The separate non-transitory computer-readable media may include computer-readable media such as a floppy drive, a disk, a tape, a DVD/CD-ROM drive, and a memory card. According to other embodiments, the software constituent elements may be loaded to the memory 340 through the network interface 330 instead of using the non-transitory computer-readable media.

The bus 320 may enable communication and data transmission between constituent elements of the advertisement display determining system 300. The bus 320 may be configured using a high-speed serial bus, a parallel bus, a storage area network (SAN) and/or another appropriate communication technology.

The network interface 330 may be a computer hardware constituent element to connect the advertisement display determining system 300 to a computer network. The network interface 330 may connect the advertisement display determining system 300 to the computer network through a wireless or wired connection.

The database 350 may serve to store and maintain information required to determine an advertisement to be displayed. The database 350 may include a situation information collector and a logger. Here, the database 350 may collect situation information from at least one sensor of a digital signage device. Also, the database 350 may log information about the extracted advertisement content for differentially determining a charge based on situation information. Although FIG. 3 illustrates that the database 350 is included within the advertisement display determining system 300, it is only an example and the present disclosure is not limited thereto. The database 350 may be omitted or the entire or a portion of the database 350 may be present as an external database constructed in a separate system based on a system configuration method or environment.

The processor 310 may be configured to process an instruction of a computer program by performing a basic calculation, a logic, and an input/output (I/O) operation of the advertisement display determining system 300. The instruction may be provided to the processor 310 through the memory 340 or the network interface 330 and the bus 320. The processor 310 may be configured to execute the program code for the register 311 and the extractor 312. The program code may be stored in a storage device such as the memory 340.

The register 311 may register advertisement content based on setting information input from an advertiser or campaign setting information input to a campaign template selected by the advertiser. The register 311 may provide a setting information interface for receiving the setting information from the advertiser or a campaign template interface for receiving the campaign setting information from the advertiser, and may output a setting result for displaying the advertisement content in response to the setting information input through the setting information interface or the campaign template interface. Here, the register 311 may receive, from the advertiser, a setting on the campaign setting information or an advertisement type for displaying the advertisement content through the campaign template.

The extractor 312 may extract the advertisement content corresponding to the situation information in response to matching between the setting information input from the advertiser or the campaign setting information input from the advertiser and the situation information. The extractor 312 may receive a response result to the displayed advertisement content in real time, and may recommend the advertisement content corresponding to the received response result and the situation information

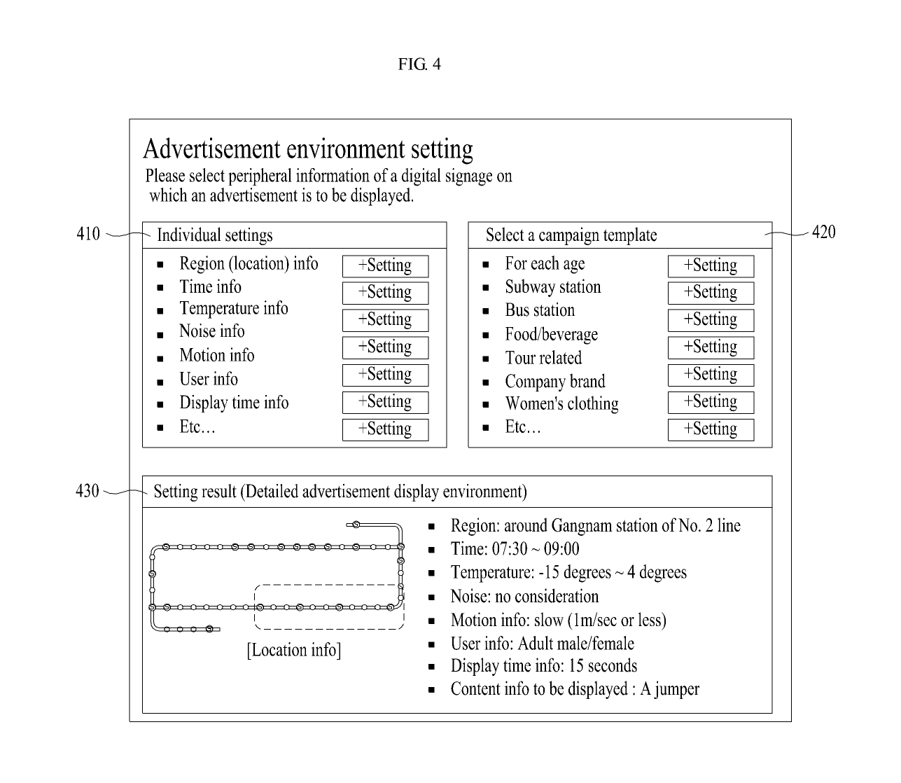

FIG. 4 illustrates a process of registering advertisement content by inputting setting information of an advertisement display determining system according to an embodiment.

Here, it is assumed that advertisement content is to be displayed on a digital signage device within a subway station. For example, an advertiser may input setting information to register advertisement content to be displayed on the digital signage device within the subway station. The advertiser may bid for situation information for displaying the advertisement content by inputting at least one set of setting information. Here, as shown in FIG. 4, the advertiser may input setting information individually (410), or may input setting information through a campaign template provided from the advertisement display determining system (420). The advertiser may register advertisement content by inputting setting information and may display the advertisement content based on the bid setting information.

The advertiser may bit for setting information to display the advertisement content on the digital signage device within the subway station. Hereinafter, an example in which the advertiser individually inputs setting information to display A jumper will be described. For example, the advertiser may input setting information such as Samsung station to Gangnam station of No. 2 line as region or location information, 07:30 to 09:00 as time information, −15 degrees to 4 degrees as temperature information, 60 decibels (dB) as noise information, 1 m/sec or less as motion information, no consideration of user information and 15 seconds as display time. Here, the advertiser may bid for at least one set of setting information and may bid for a plurality of sets of setting information as described above.

Alternatively, an example in which the advertiser inputs setting information through the campaign template provided from the advertisement display determining system to register advertisement content to be displayed on the digital signage device within the subway station will be described. For example, the advertiser may input setting information such as no consideration of an age, Samsung station to Gangnam station of No. 2 line, no setting of a bus station, A brand as a company brand, and A jumper as clothing.

The setting information 410 or 420 input from the advertiser may be output through a setting result area 430. Here, the setting result area 430 displays a detailed environment for displaying advertisement content input from the advertiser. For example, the setting result about setting information bid for by the advertiser may be output such that a region is around Gangnam station of No. 2 line, a time is between 07:30 and 09:00, a temperature is between −15 degrees and 4 degrees, noise is not considered, motion information is slow (1 m/sec or less), user information is an adult male/female, display time information is 15 seconds, and content information to be displayed is A jumper.

The advertisement display determining system may register the advertisement content based on the setting information 410 input from the advertiser or the setting information 420 input to the campaign template selected from the advertiser.

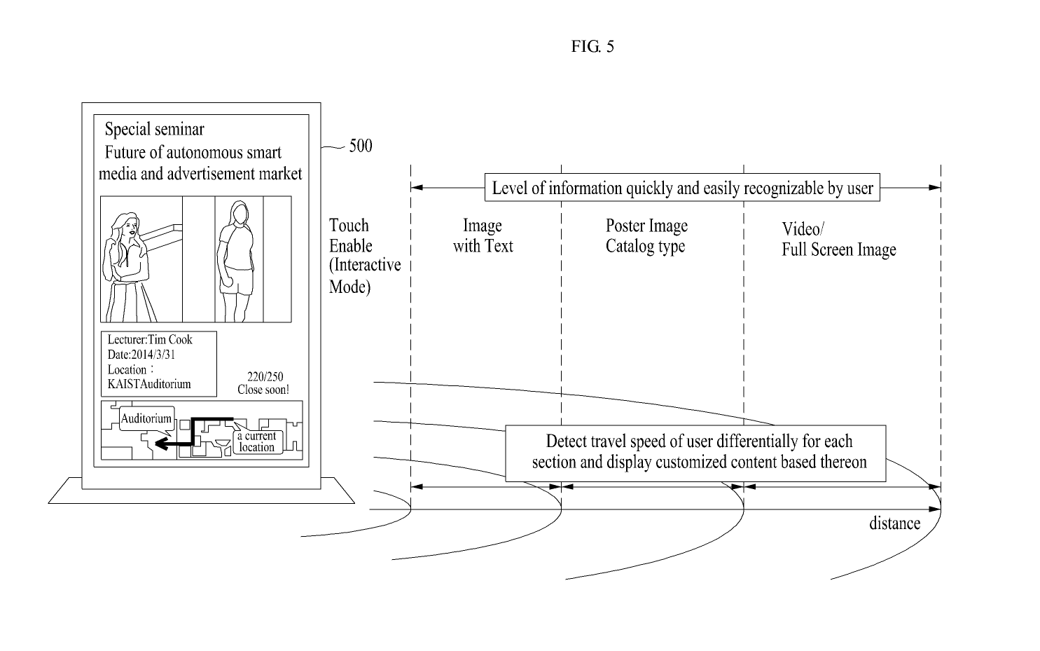

FIG. 5 illustrates an example of displaying advertisement content on a digital signage device according to an embodiment.

As described above with reference to FIG. 4, an advertisement display determining system may register advertisement content based on setting information input from an advertiser or campaign setting information input to a campaign template selected from the advertiser. In an example in which a seminar is to be held in KAIST Auditorium, the subject of this special seminar may be the future of autonomous smart media and advertisement market, a lecturer may be Tim cook, a date may be Mar. 31, 2014, and a location may be KAIST Auditorium. Referring to FIG. 5, the advertiser may register a seminar advertisement and may bid for setting information for displaying the seminar advertisement. To increase a participation rate of participants in the seminar, the advertiser may bid for setting information such as a university including a corresponding department as a region, a timeline in which students move around the university, for example, a time zone between 09:00 a.m. and 06:00 p.m. as a time, Mar. 2, 2014 to Mar. 31, 2014 as a period, 20 or more as the number of detected users, and 1 m/sec or less as a travel speed of a user.

The advertisement display determining system may collect situation information from at least one sensor of a digital signage device 500. In this instance, a sensor may be added to or removed from the digital signage device 500. Accordingly, a variety of situation information may occur. Here, the situation information may indicate a region or a location, a current time, a temperature, a humidity, noise, user motion information, and user information. For example, the advertisement display determining system may collect situation information from the digital signage device 500 in real time and may also collect situation information from the digital signage device 500 at predetermined intervals.

Advertisement content corresponding to the situation information may be extracted in response to matching between setting information bid for by the advertiser and the situation information. The advertisement display determining system may transfer the extracted advertisement content to the digital signage device 500, and the digital signage device 500 may display the transferred advertisement content.

For example, the digital signage device 500 may detect a location and a travel speed of a user, and may display advertisement content in a touch-enable interactive mode, an image mode with a text, a poster image mode of a catalogue type, and a full screen image/video mode. The digital signage device 500 may provide customized content based on the detected location and travel speed of the user, thereby enabling the user to quickly and easily recognize the customized content. Also, when the advertisement display determining system includes an advertisement content delivery function, the advertisement display determining system may interact with the advertisement content through separate connection to the digital signage device 500.

For example, the digital signage device 500 may display the seminar advertisement. In detail, the digital signage device 500 may output the seminar advertisement such that the subject of this special seminar is the future of autonomous smart media and advertisement market, a lecturer is Tim cook, a date is Mar. 31, 2014, and a location is KAIST Auditorium. Also, the digital signage device 500 may indicate and thereby display a location of the seminar on a map. Also, the digital signage device 500 may display the number of participants participating in the seminar in real time. Here, the digital signage device 500 may output advertisement content based on the setting information input from the advertiser, for example, a size and a location of the advertisement content to be displayed on the digital signage device 500.

The advertisement display determining system may log the displayed advertisement content for differentially determining a charge based on situation information. The advertisement display determining system may log information created in response to an interaction between the displayed advertisement content and an outside, and may differentially determine a charge by assigning a weight to the created information. Also, the advertisement display determining system may determine to display an advertisement by continuously logging user reactions accumulated from a point in time at which the advertisement content is displayed and by applying the logged user reactions when displaying the advertisement content next time.

The advertisement display determining system may differentially determine a charge based on a display of advertisement content for each situation. For example, cost according to the display of advertisement content may be calculated according to “(time according to display of advertisement content*weight for each time zone)*weight for adjacent user”, and cost about interaction may be calculated according to “interaction weight (interaction about advertisement content*weight for each interaction)”.

For example, when a temperature is determined to be relatively high based on temperature information within a subway station, the advertisement display determining system may differentially determine a cost based on a temperate at which an advertisement associated with frozen desserts or beverages is to be displayed. As the temperature increases, the advertisement associated with frozen desserts or beverages may be further effectively recognized by a user. Also, when displaying a fast working digestive medicine advertisement based on a noise decibel of a subway approaching a station within a subway station, the advertisement display determining system may display advertisement content based on a time at which a user gets on and off the subway, and may differentially determine a charge based on the noise decibel.

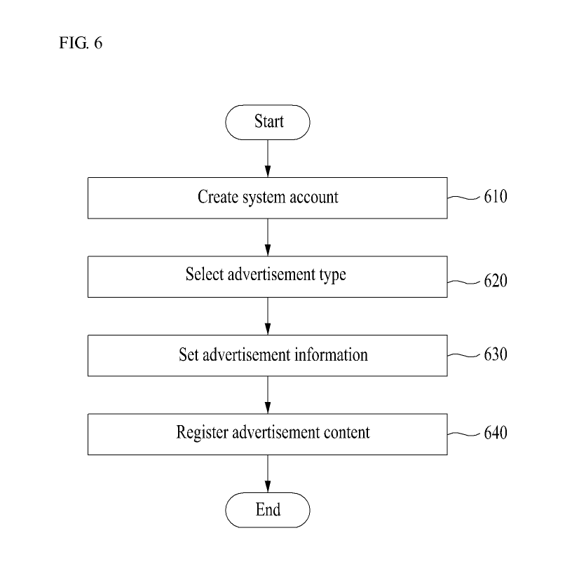

FIG. 6 is a flowchart illustrating a method of registering advertisement content from an advertiser in an advertisement display determining system according to an embodiment.

The advertiser may input setting information for registering advertisement content. Here, the advertisement display determining system may receive setting information by providing a campaign template to the advertiser, and may receive setting information by receiving setting information about the advertisement content from the advertiser. An example of registering advertisement content by receiving setting information through a campaign template provided from the advertisement display determining system will be described with reference to FIG. 6.

In operation 610, the advertisement display determining system may create a system account of the advertiser. The advertiser may bid for situation information of a digital signage device to display advertisement content on a digital signage device through the created system account. In operation 620, the advertiser may select an advertisement type of the advertisement content. In this instance, the advertiser may select a display advertisement or an interactive advertisement as the advertisement type, and may select product information about the advertisement content to be displayed. For example, to register an advertisement associated with frozen desserts, the advertiser may set situation information such that an illumination is high, a temperature is high, a humidity is high, and a motion is high.

In operation 630, the advertisement display determining system may set advertisement information based on setting information input from the advertiser. The advertiser may set an advertisement period, advertisement cost, an advertisement target user, and a method of recognizing the advertisement target user individually or through a campaign template. For example, since advertisement cost is set by the advertiser, the advertisement display determining system may provide a function of setting a maximum upper limit of cost per display for an advertisement based on a response rate. Also, the advertisement display determining system may provide a function of recognizing an advertisement target user through a gaze and a motion. For example, when a motion of the user is slowed down, the advertisement display determining system may recognize the advertisement target user based on noise, brightness, and a temperature around a signage device, and the number of users.

In operation 640, the advertisement display determining system may register the advertisement content based on advertisement information and the advertisement type set by the advertiser. In this instance, the advertisement display determining system may automatically recommend advertisement content with omitting an operation of setting advertisement information based on the advertisement type of advertisement content selected by the advertiser.

The advertisement display determining system according to an embodiment may provide the convenience in registering and setting advertisement content of an advertiser by providing a campaign template, and may display advertisement content optimal for a situation through a bid for advertisement content based on situation information.

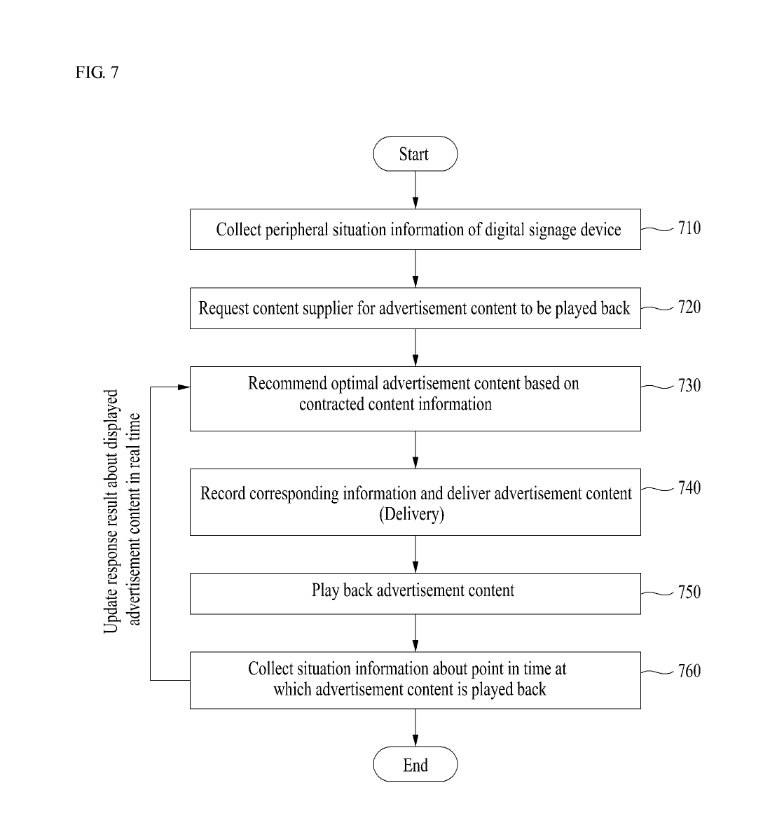

FIG. 7 is a flowchart illustrating an advertisement display determining method of an advertisement display determining system according to an embodiment.

In operation 710, the advertisement display determining system may collect peripheral situation information of a digital signage device. In this instance, the advertisement display determining system may collect the number of users recognizable from the digital signage device, a presence or an absence of a motion of a recognizable user, a travel speed of the recognizable user, and recognizable user information, and may also collect at least one situation information among temperature information, humidity information, illumination information, sound information, and CO2 information that are recognized from the digital signage device, and information of the digital signage information including a length and a width of the digital signage device and a location of the digital signage device from the ground. The advertisement display determining system may recognize a sensor added to or removed from the digital signage device, and may collect a plurality of sets of situation information according to the added or removed sensor. In this instance, the advertisement display determining system may improve accuracy and elaboration of situation information by correcting the collected situation information.

In operation 720, the advertisement display determining system may request a content provider for advertisement content to be played back. The advertisement display determining system may request advertisement content that satisfies situation information of the digital signage device. In this instance, the advertisement display determining system may provide terminal information of a signage device to play back the advertisement content and peripheral situation information of the signage device, so that the content provider may provide optimal advertisement content.

In operation 730, the advertisement display determining system may recommend the optimal advertisement content based on information about the advertisement content contracted with the advertiser. The advertisement display determining system may extract advertisement content corresponding to situation information of the digital signage device in response to matching between situation information bid for by the advertiser and situation information of the digital signage device. For example, the advertisement display determining system may select advertisement content based on a response rate of advertisement content displayed during at least a predetermined period of time and situation information.

In operation 740, the advertisement display determining system may record information about the advertisement content to be displayed and may deliver the advertisement content to be displayed to the digital signage device. In this instance, the advertisement display determining system may log information about the advertisement content and may use the logged information as an index to measure whether the advertisement content is accurately displayed. An index value may be differently recorded based on a display characteristic of the advertisement content. The index value may be stored even in the digital signage device during a predetermined period of time of the advertisement display determining system and thus, the reliability of information about the advertisement content may be enhanced.

In operation 750, the advertisement display determining system may play back the advertisement content. In operation 740, the advertisement display determining system may transmit the advertisement content to the digital signage device and the digital signage device may display the advertisement content.

In operation 760, the advertisement display determining system may collect situation information about a point in time at which the advertisement content is played back. Here, when direct interaction information between a signage device and the user is present, the advertisement display determining system may also collect the interaction information. By updating the collected interaction information and a response result about the displayed advertisement content in real time, the updated information may be applied to recommend the advertisement content in operation 730. The advertisement display determining system may log information created in response to an interaction between the displayed advertisement and an outside and may differentially determine a charge by assigning a weight to the created information.

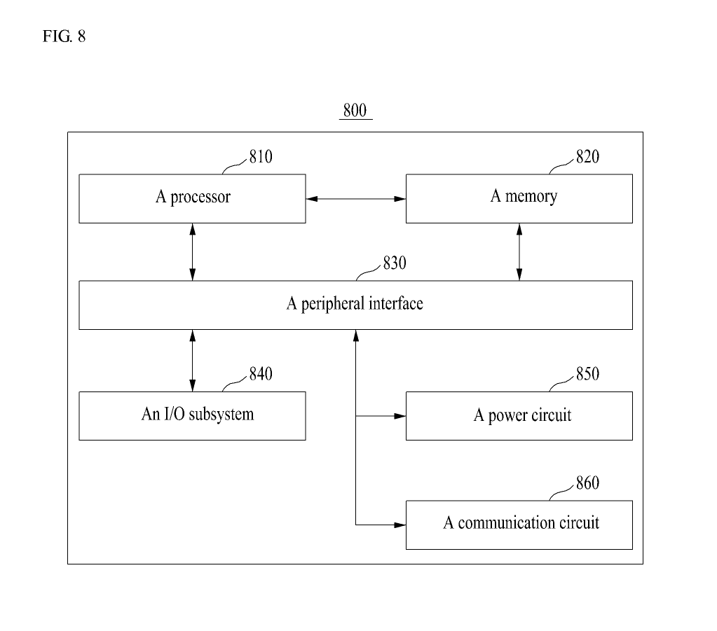

FIG. 8 is a block diagram illustrating an example of a configuration of a computer system 800 according to an embodiment.

Referring to FIG. 8, the computer system 800 may include at least one processor 810, a memory 820, a peripheral interface 830, an I/O subsystem 840, a power circuit 850, and a communication circuit 860. Here, the computer system 800 may correspond to a user device.

The memory 820 may include, for example, a high-speed random access memory (HSRAM), a magnetic disk, a static random access memory (SRAM), a dynamic RAM (DRAM), read only memory (ROM), a flash memory, and a non-volatile memory. The memory 820 may include a software module, an instruction set, or a variety of data required for an operation of the computer system 800. Here, an access from another component such as the processor 810 and the peripheral interface 830 to the memory 820 may be controlled by the processor 810.

The peripheral interface 830 may couple an input device and/or output device of the computer system 800 with the processor 810 and the memory 820. The processor 810 may perform a variety of functions for the computer system 800 and process data by executing the software module or the instruction set stored in the memory 820.

The I/O subsystem 840 may couple various I/O peripheral devices with the peripheral interface 830. For example, the I/O subsystem 840 may include a controller for coupling the peripheral interface 830 and a peripheral device such as a monitor, a keyboard, a mouse, a printer, and a touch screen or a sensor depending on a necessity. The I/O peripheral devices may be coupled with the peripheral interface 830 without using the I/O subsystem 840.

The power circuit 850 may supply a power to all of or a portion of components of a terminal. For example, the power circuit 850 may include a power management system, at least one power source such as a battery and alternating circuit (AC), a charge system, a power failure detection circuit, a power converter or inverter, a power status indicator, or other components for creating, managing and distributing power.

The communication circuit 860 enables communication with another computer system using at least one external port. Alternatively, as described above, the communication circuit 860 may enable communication with another computer system by including a radio frequency (RF) circuit and thereby transmitting and receiving an RF signal known as an electromagnetic signal.

The embodiment of FIG. 8 is only an example of the computer system 800. The computer system 800 may have a configuration or an arrangement for omitting a portion of the components illustrated in FIG. 8, further including components not illustrated in FIG. 8, or coupling two or more components. For example, a computer system for a communication terminal of a mobile environment may further include a touch screen, a sensor, and the like, in addition to the components of FIG. 8. A circuit for RF communication using a variety of communication methods, for example, wireless fidelity (Wi-Fi), 3^{rd} generation (3G), long term evolution (LTE), Bluetooth, near field communication (NFC), and ZigBee, may be included in the communication circuit 860. Components includable in the computer system 800 may be configured as hardware that includes an integrated circuit specified for at least one signal processing or application, software, or a combination of hardware and software.

The methods according to the embodiments of the present disclosure may be configured in a program instruction form executable through various computer systems and thereby recorded in non-transitory computer-readable media. A program according to the embodiment may be configured as a PC-based program or an application exclusive for a mobile terminal. Also, such application may be installed in a user terminal through a file provided from a file distribution system. As an example, the file distribution system may include a file transmitter (not shown) to transmit the file in response to a request of the user terminal.

As described above, according to embodiments, it is possible to provide optimal advertisement content capable of satisfying all of an advertiser and a user by displaying advertisement content based on collected situation information, by logging information about the displayed advertisement content, and by differentially determining a charge.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described example embodiments of the present disclosure may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments of the present disclosure, or vice versa.

Although a few example embodiments of the present disclosure have been shown and described, the present disclosure is not limited to the described example embodiments. Instead, it would be appreciated by those skilled in the art that changes may be made to these example embodiments without departing from the principles and spirit of the disclosure, the scope of which is defined by the claims and their equivalents.

What is claimed is:

1. An advertisement display determining method configured as a computer, the method comprising:
collecting situation information from at least one sensor of a digital signage device;
registering advertisement content based on setting information input from an advertiser or campaign setting information input to a campaign template selected by the advertiser;
extracting the advertisement content corresponding to the situation information in response to matching between the setting information input from the advertiser or the campaign setting information input from the advertiser and the situation information; and
providing the extracted advertisement content to the digital signage device, and logging the advertisement content for differentially determining a charge based on the situation information.

2. The method of claim 1, wherein the registering of the advertisement content comprises:
providing a setting information interface for receiving the setting information from the advertiser or a campaign template interface for receiving the campaign setting information from the advertiser; and
outputting a setting result for displaying the advertisement content in response to the setting information input through the setting information interface or the campaign template interface.

3. The method of claim 2, wherein the registering of the advertisement content comprises receiving, from the advertiser, a setting on the campaign setting information or an advertisement type for displaying the advertisement content through the campaign template.

4. The method of claim 1, wherein the providing and the logging comprises logging the situation information about a point in time at which the advertisement content is displayed through the digital signage device.

5. The method of claim 4, wherein the providing and the logging comprises logging information created in response to an interaction between the displayed advertisement content and an outside, and differentially determining the charge by assigning a weight to the created information.

6. The method of claim 1, wherein the extracting comprises receiving a response result to the displayed advertisement content in real time, and recommending the advertisement content corresponding to the received response result and the situation information.

7. The method of claim 1, wherein the collecting comprises collecting at least one situation information among the number of users recognizable from the digital signage device, a presence or an absence of a motion of a recognizable user, a travel speed of the recognizable user, recognizable user information, and temperature information, humidity information, illumination information, sound information, and CO2 information that are recognized from the digital signage device, and information of the digital signage information, and correcting the collected situation information.

8. An advertisement display determining system configured as a computer, the system comprising:
a situation information collector configured to collect situation information from at least one sensor of a digital signage device;
a register configured to register advertisement content based on setting information input from an advertiser or campaign setting information input to a campaign template selected by the advertiser;
an extractor configured to extract the advertisement content corresponding to the situation information in response to matching between the setting information input from the advertiser or the campaign setting information input from the advertiser and the situation information; and
a logger configured to provide the extracted advertisement content to the digital signage device, and to log the advertisement content for differentially determining a charge based on the situation information.

9. The system of claim 8, wherein the register is configured to provide a setting information interface for receiving the setting information from the advertiser or a campaign template interface for receiving the campaign setting information from the advertiser, and to output a setting result for displaying the advertisement content in response to the setting information input through the setting information interface or the campaign template interface.

10. The system of claim 9, wherein the register is configured to receive, from the advertiser, a setting on the campaign setting information or an advertisement type for displaying the advertisement content through the campaign template.

11. The system of claim 8, wherein the logger is configured to log the situation information about a point in time at which the advertisement content is displayed through the digital signage device.

12. The system of claim 11, wherein the logger is configured to log information created in response to an interaction between the displayed advertisement content and an outside, and to differentially determine the charge by assigning a weight to the created information.

13. The system of claim 8, wherein the extractor is configured to receive a response result to the displayed advertisement content in real time, and to recommend the advertisement content corresponding to the received response result and the situation information.

14. The system of claim 8, wherein the situation information collector is configured to collect at least one situation information among the number of users recognizable from the digital signage device, a presence or an absence of a motion of a recognizable user, a travel speed of the recognizable user, recognizable user information, and temperature information, humidity information, illumination information, sound information and CO2 information that are recognized from the digital signage device, and information of the digital signage information, and to correct the collected situation information.

15. Non-transitory computer-readable media comprising an instruction to control a computer system to determine an advertisement to be displayed, wherein the instruction controls the computer system by a method comprising:
collecting situation information from at least one sensor of a digital signage device;
registering advertisement content based on setting information input from an advertiser or campaign setting information input to a campaign template selected by the advertiser;
extracting the advertisement content corresponding to the situation information in response to matching between the setting information input from the advertiser or the campaign setting information input from the advertiser and the situation information; and
providing the extracted advertisement content to the digital signage device, and logging the advertisement content for differentially determining a charge based on the situation information.
